(19) United States
(12) Patent Application Publication
(10) Pub. No.: US 2024/0375214 A1
(43) Pub. Date: Nov. 14, 2024

(54) LASER MACHINING APPARATUS AND LASER MACHINING METHOD

(71) Applicant: Mitsubishi Electric Corporation, Tokyo (JP)

(72) Inventors: Takanori MIYAZAKI, Tokyo (JP); Kazunori NAGAI, Tokyo (JP)

(73) Assignee: Mitsubishi Electric Corporation, Tokyo (JP)

(21) Appl. No.: 18/564,625

(22) PCT Filed: Oct. 25, 2021
(86) PCT No.: PCT/JP2021/039296

§ 371 Date: Nov. 28, 2023

(51) Int. Cl. B23K 26/082; B23K 26/0622; B23K 26/14; B23K 26/38

(52) U.S. Cl. CPC B23K 26/082; B23K 26/0622; B23K 26/1437; B23K 26/1462; B23K 26/38

(57) ABSTRACT

A control unit performs: a control of forming a cut groove by running a first laser beam along a machining path in an in-plane direction of an upper surface of the workpiece; a control of stopping irradiation with the first laser beam when an irradiation position of the laser beam reaches a position short of an end point on the machining path; and a control of continuing ejection of gas over a first waiting time. The control unit performs: a control of irradiating the workpiece with a second laser beam that gives less thermal energy to the workpiece per unit time than the first laser beam; and a control of forming a joint portion coupling the product and the offcut by running the second laser beam in an uncut region on the machining path, the joint portion having a thickness smaller than a thickness of the workpiece.

### FIELD

The present disclosure relates to a laser machining apparatus and a laser machining method for irradiating a workpiece with a laser beam to cut the workpiece.

### BACKGROUND

In conventional cutting of a workpiece using a laser, a plurality of products can be cut out from one plate-like workpiece. For cutting out a plurality of products from one workpiece through laser machining, a cutting method called micro-joint method is used in order to prevent failure in laser machining or collection of products due to movement of the cut-out products. Micro-joint method is a machining method for keeping a workpiece and a product coupled by a fine coupling portion called a joint portion so as not to completely separate the product from the workpiece. Then, by applying an impact to the joint portion at the time when all the cutting processes on the workpiece are completed, the product is separated from the offcut, i.e. portion of the workpiece other than the product.

Patent Literature 1 discloses that a coupling piece is formed between a workpiece and a product in a manner that does not cut entirely through the workpiece by causing the speed of cutting the workpiece higher, and the output of laser light lower, compared with those values for cutting out the product from the workpiece.

### CITATION LIST

### Patent Literature

Patent Literature 1: Japanese Patent No. 4605690

### Summary of Invention

### Problem to be solved by the Invention

However, the adjustment of machining conditions according to the technique of Patent Literature 1, namely increasing the cutting speed and reducing the cutting output, is unsuitable for obtaining a coupling piece having a desired shape. When machining is performed under the conditions of increased cutting speed and reduced cutting output, the laser beam may move before the workpiece positioned above the coupling piece is certainly melted. For this reason, the technique of Patent Literature 1 has a possibility in that a desired shape cannot be stably obtained.

In addition, as the cutting speed is increased, the speed at which the machining gas moves also becomes higher. In this case, there is a possibility in that the discharge of melt by the laser beam from the cut groove with the machining gas cannot keep up with the melting of the workpiece. Therefore, the technique of Patent Literature 1 has a possibility in that, because the discharge of melt cannot keep up with the cutting speed at the time of forming the coupling piece, melt may remain undischarged downward from the cut groove of the workpiece and may blow up to the upper side of the workpiece. The blow-up of melt to the upper side of the workpiece makes it impossible to obtain the coupling piece having a desired shape, and causes the product to be covered with melt, resulting in a machining defect in the whole cutting.

The present disclosure has been made in view of the above, and an object thereof is to obtain a laser machining apparatus capable of reliably forming a coupling piece that has a desired shape and couples the workpiece and the product in laser beam cutting.

Means to Solve the Problem

In order to solve the above-described problems and achieve the object, a laser machining apparatus according to the present disclosure performs cutting to separate a workpiece into a product and an offcut by irradiating the workpiece with a laser beam and ejecting gas to the workpiece. The laser machining apparatus includes: a machining head that irradiates the workpiece with the laser beam; a gas nozzle that ejects gas to the workpiece; a drive unit that moves at least one of the workpiece and the machining head; and a control unit that controls irradiation with the laser beam. The control unit performs: a control of forming a cut groove by running a first laser beam along a predetermined machining path conforming to an outer shape of the product in an in-plane direction of an upper surface of the workpiece that is a surface irradiated with the laser beam; a control of stopping irradiation with the first laser beam when an irradiation position of the laser beam reaches a position short of an end point on the machining path; and a control of continuing ejection of the gas over a predetermined first waiting time while the irradiation with the first laser beam is stopped. The control unit performs: a control of irradiating the workpiece with a second laser beam that gives less thermal energy to the workpiece per unit time than the first laser beam; a control of keeping irradiation of the workpiece with the second laser beam over a predetermined second waiting time; and a control of forming a joint portion coupling the product and the offcut by running the second laser beam in an uncut region where the cut groove is not formed on the machining path, the joint portion having a thickness smaller than a thickness of the workpiece, in a thickness direction of the workpiece.

### Effects of the Invention

The present disclosure can achieve the effect of reliably forming a coupling piece that has a desired shape and couples the workpiece and the product in laser beam cutting.

### BRIEF DESCRIPTION OF DRAWINGS

FIG. 1 is a diagram illustrating a functional configuration of a laser machining apparatus according to a first embodiment.

FIG. 2 is a plan view illustrating a workpiece in a state in which cutting with the laser machining apparatus illustrated in FIG. 1 is completed.

FIG. 3 is a perspective view illustrating a product and a joint portion in a state in which cutting with the laser machining apparatus illustrated in FIG. 1 is completed.

FIG. 4 is a plan view for explaining a method of cutting the workpiece with the laser machining apparatus illustrated in FIG. 1.

FIG. 5 is a flowchart illustrating a procedure for the method of cutting the workpiece with the laser machining apparatus illustrated in FIG. 1.

FIG. 6 is a schematic cross-sectional view for explaining the method of cutting the workpiece with the laser machining apparatus illustrated in FIG. 1.

FIG. 7 is a schematic cross-sectional view for explaining the method of cutting the workpiece with the laser machining apparatus illustrated in FIG. 1.

FIG. 8 is a schematic cross-sectional view for explaining the method of cutting the workpiece with the laser machining apparatus illustrated in FIG. 1.

FIG. 9 is a schematic cross-sectional view for explaining the method of cutting the workpiece with the laser machining apparatus illustrated in FIG. 1.

FIG. 10 is a schematic cross-sectional view for explaining the method of cutting the workpiece with the laser machining apparatus illustrated in FIG. 1.

FIG. 11 is a schematic cross-sectional view for explaining the method of cutting the workpiece with the laser machining apparatus illustrated in FIG. 1.

FIG. 12 is a cross-sectional view for explaining the concept of machining phenomena on the workpiece with a pulsed laser beam.

FIG. 13 is a time chart for the cutting of the workpiece with the laser machining apparatus illustrated in FIG. 1.

FIG. 14 is a diagram illustrating examples of dimensions of the joint portion formed in the cutting of the workpiece with the laser machining apparatus illustrated in FIG. 1.

FIG. 15 is a diagram illustrating examples of machining conditions and dimensions of the joint portion in the cutting of the workpiece with the laser machining apparatus illustrated in FIG. 1.

FIG. 16 is a diagram illustrating detailed machining conditions for cutting under conditions (2), (4), and (5) in the examples illustrated in FIG. 15.

FIG. 17 is a diagram illustrating a hardware configuration for implementing the functions of the control unit illustrated in FIG. 1.

### DESCRIPTION OF EMBODIMENTS

Hereinafter, a laser machining apparatus and a laser machining method according to an embodiment will be described in detail based on the drawings.

### First Embodiment.

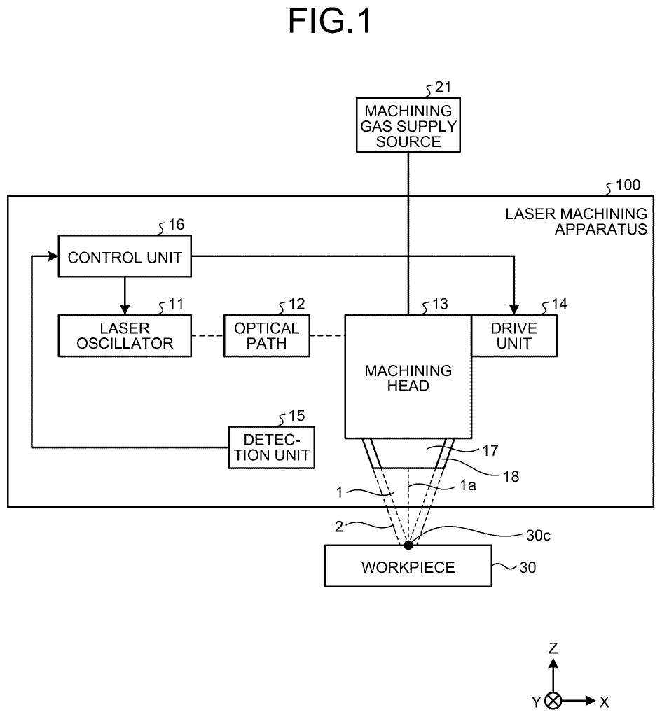

FIG. 1 is a diagram illustrating a functional configuration of a laser machining apparatus 100 according to the first embodiment.

The laser machining apparatus 100 has a function of cutting a plate-like workpiece 30 by irradiating the workpiece 30 with a pulsed laser beam 1. That is, the laser machining apparatus 100 is a laser machining apparatus that performs cutting to separate the workpiece 30 into a product 30a and an offcut 30b to be described later by irradiating a machining point 30c on the workpiece 30 with a laser beam and ejecting a machining gas 2 to the machining point 30c.

The workpiece 30 in the first embodiment is a plate-like workpiece made of, for example, stainless steel. Note that the material constituting the workpiece 30 is not limited to stainless steel, and various types of materials can be used.

The laser machining apparatus 100 includes a laser oscillator 11, an optical path 12, a machining head 13, a drive unit 14, a detection unit 15, and a control unit 16. In FIG. 1, the X axis, the Y axis, and the Z axis are three axes perpendicular with each other. The X axis and the Y axis are axes parallel to the horizontal direction, for example. The Z axis is an axis parallel to the vertical direction, for example.

The laser oscillator 11 generates a laser beam for use in cutting the workpiece 30. That is, the laser oscillator 11 oscillates and emits a laser beam for use in cutting the workpiece 30. The laser oscillator 11 used in the laser machining apparatus 100 according to the first embodiment is a laser oscillator that emits the pulsed laser beam 1. Therefore, the laser beam for use in cutting the workpiece 30 in the first embodiment is the pulsed laser beam 1.

Note that a continuous wave laser beam may be used for cutting. That is, in the cutting of the workpiece 30 with the laser machining apparatus 100, the pulsed laser beam 1 or a continuous laser beam can be used. In the case of using a continuous wave laser beam for laser beam cutting, the laser machining apparatus 100 includes the laser oscillator 11 that emits a pulsed laser beam and the laser oscillator 11 that emits a continuous wave laser beam. In this case, in the laser machining apparatus 100, the continuous wave laser beam is used for cutting the workpiece 30, and the pulsed laser beam is used for forming a joint portion.

The pulsed laser beam 1 emitted from the laser oscillator 11 is supplied to the machining head 13 via the optical path 12. The optical path 12 is a path for transmitting the pulsed laser beam 1 emitted by the laser oscillator 11 to the machining head 13, and may be a path for propagating the pulsed laser beam 1 in the air or a path for transmitting the pulsed laser beam 1 through an optical fiber. The optical path 12 is designed according to the characteristics of the pulsed laser beam 1.

The machining head 13 includes an optical system that focuses the pulsed laser beam 1 on the workpiece 30, and irradiates the machining point 30c with the pulsed laser beam 1. The machining head 13 focuses the supplied pulsed laser beam 1 to irradiate one surface of the workpiece 30, which is a surface to be machined of the workpiece 30. The machining head 13 preferably includes an optical system that has a focal point near the surface of the workpiece 30.

The machining head 13 includes a beam nozzle 17 and a gas nozzle 18 on the side facing the workpiece 30.

The beam nozzle 17 emits the pulsed laser beam 1 toward the workpiece 30.

The gas nozzle 18 ejects the machining gas 2 toward the workpiece 30. The gas nozzle 18 is a gas ejection nozzle that ejects the machining gas 2 from the machining head 13 to the machining point 30c at which the workpiece 30 is irradiated with the pulsed laser beam 1. Specifically, the gas nozzle 18 ejects, toward the optical axis la, the machining gas 2 from outside an optical axis la of the pulsed laser beam 1 with which the workpiece 30 is irradiated from the machining head 13. As the machining gas 2, for example, an inert gas such as nitrogen or oxygen can be used. In the machining head 13, the gas nozzle 18 is provided coaxially with the beam nozzle 17 on the outer circumferential side of the beam nozzle 17 in the XY plane, and ejects the machining gas 2 along the central axis of the pulsed laser beam 1 emitted from the beam nozzle 17. That is, the beam nozzle 17 and the gas nozzle 18 are disposed coaxially with each other.

Note that the gas nozzle 18 may eject the gas in a direction oblique to the Z axis. That is, the gas nozzle 18 may eject the gas in a direction oblique to the central axis of the pulsed laser beam 1 emitted from the beam nozzle 17. The machining gas 2 is supplied to the gas nozzle 18 from a machining gas supply source 21 such as a gas cylinder provided outside the laser machining apparatus 100. Note that the machining gas supply source 21 may be included in the laser machining apparatus 100.

The drive unit 14 can control and change the relative positional relationship between the machining head 13 and the workpiece 30 by changing the position of the machining head 13. Note that although the drive unit 14 of the laser machining apparatus 100 is configured to change the relative positional relationship between the machining head 13 and the workpiece 30 by changing the position of the machining head 13, the drive unit 14 may change the position of the table on which the workpiece 30 is placed, or change the positions of both the machining head 13 and the table on which the workpiece 30 is placed. That is, the drive unit 14 only needs to have a function of moving the machining head 13 and/or the workpiece 30. The machining head 13 irradiates the workpiece 30 with the pulsed laser beam 1 while the drive unit 14 changes the relative positional relationship between the machining head 13 and the workpiece 30, so that the workpiece 30 can be cut.

The detection unit 15 is a sensor that detects the state of the workpiece 30 or the state of the laser machining apparatus 100. The detection unit 15 measures, as time-series signals, measurement values of physical quantities such as the position of the workpiece 30 during machining, the intensity and wavelength of light generated during machining, sound waves, and ultrasonic waves. The detection unit 15 is, for example, a capacitance sensor, a photodiode, a charge coupled device (CCD) sensor, a complementary metal oxide semiconductor (CMOS) sensor, a spectral spectrometer, an acoustic sensor, an acceleration sensor, a gyro sensor, a distance sensor, a position detector, a temperature sensor, a humidity sensor, and the like. The detection unit 15 inputs the time-series signals indicating measurement values to the control unit 16.

The control unit 16 controls components including the laser oscillator 11 and the drive unit 14 such that the pulsed laser beam 1 runs a predetermined machining path on the workpiece 30 according to the set machining conditions and the measurement values sent from the detection unit 15.

That is, the control unit 16 controls on and off of the pulsed laser beam 1 from the laser oscillator 11, output of the pulsed laser beam 1 from the laser oscillator 11, positioning of the drive unit 14, pressure of the machining gas 2 from the machining gas supply source 21, on and off of the machining gas 2, ejection pressure of the machining gas 2, and the like.

The machining conditions include, for example, the material of the workpiece 30, the thickness of the workpiece 30, and the state of the surface of the workpiece 30. The machining conditions further include conditions related to the laser oscillator 11, such as laser output intensity, laser output frequency, duty ratio of laser output, mode, waveform, and wavelength. The machining conditions can include the focal position of the pulsed laser beam 1, the focus diameter of the pulsed laser beam 1, the type of the machining gas 2 ejected from the gas nozzle 18, the gas pressure of the machining gas 2, the hole diameter of the gas nozzle 18, the machining speed, and the like. The machining conditions can also include measurement values input from the detection unit 15, such as the distance between the workpiece 30 and the machining head 13, temperature, and humidity.

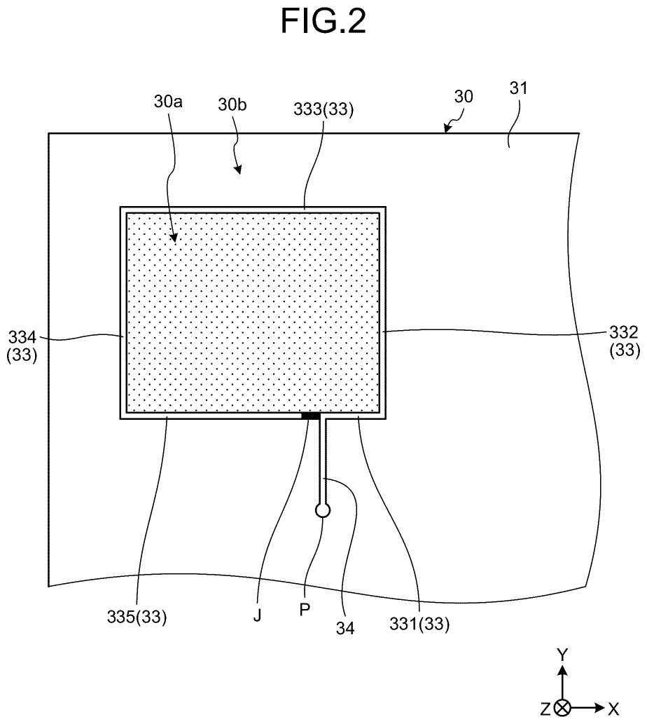

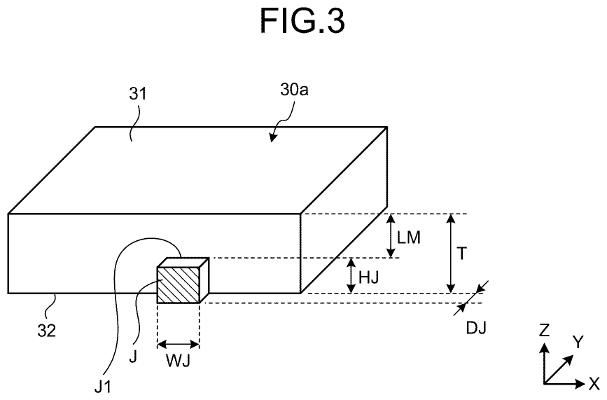

Next, the workpiece 30 in a state in which cutting with the laser machining apparatus 100 is completed will be described. FIG. 2 is a plan view illustrating the workpiece 30 in a state in which cutting with the laser machining apparatus 100 illustrated in FIG. 1 is completed. Although FIG. 2 is a plan view, the product 30a in FIG. 2 is hatched for easy understanding. FIG. 3 is a perspective view illustrating the product 30a and a joint portion J in a state in which cutting with the laser machining apparatus 100 illustrated in FIG. 1 is completed. FIG. 3 is a view featuring the product 30a and the joint portion J from the workpiece 30 in a state in which cutting with the laser machining apparatus 100 is completed, and does not depict the offcut 30b.

Here, the direction of a workpiece thickness T that is the thickness of the workpiece 30, i.e. the thickness direction of the workpiece 30, can be rephrased as the plate thickness direction of the workpiece 30. The plate thickness direction is a direction that is parallel to the height direction of the joint portion J and extends in the Z-axis direction. The in-plane direction of the workpiece 30 is a direction parallel to the XY plane.

The laser machining apparatus 100 performs cutting to separate the workpiece 30 into the product 30a and the offcut 30b by irradiating the irradiation surface of the workpiece 30 with the pulsed laser beam 1. The irradiation surface is one surface of the workpiece 30 irradiated with the pulsed laser beam 1, and is an upper surface 31 of the workpiece 30. That is, the upper surface 31 is the surface close to the machining head 13 among a pair of surfaces of the workpiece 30 facing each other in the thickness direction of the workpiece 30, and is the surface irradiated with the pulsed laser beam 1 on the workpiece 30.

The product 30a is used as merchandise or the like after cutting. The offcut 30b is an unnecessary portion left after cutting. The position at which the workpiece 30 is irradiated with the pulsed laser beam 1 is controlled by the control unit 16, and moves along a predetermined machining path.

As illustrated in FIG. 2, the workpiece 30 in a state in which cutting with the laser machining apparatus 100 is completed still has the product 30a connected to the offcut 30b by the joint portion J. A cut groove 33 is formed between the product 30a and the offcut 30b as a result of cutting. The cut groove 33 is a through groove cut entirely through the workpiece 30 in the direction of the workpiece thickness T, i.e. the thickness of the workpiece 30, that is, in the plate thickness direction of the workpiece 30.

The cut groove 33 is composed of a cut groove 331 which is a cut groove along the X-axis direction, a cut groove 332 which is a cut groove along the Y-axis direction, a cut groove 333 which is a cut groove along the X-axis direction, a cut groove 334 which is a cut groove along the Y-axis direction, and a cut groove 335 which is a cut groove along the X-axis direction, which are connected in this order. In addition, as will be described later, the offcut 30b has a cut groove 34 connecting a piercing hole P formed first in the cut groove forming process and the cut groove 331.

One joint portion J is formed in a part between the product 30a and the offcut 30b. The joint portion J is a coupling portion that couples the workpiece 30 and the product 30a, that is, a coupling portion that couples the product 30a and the offcut 30b. That is, in the workpiece 30 for which cutting with the laser machining apparatus 100 has been completed, the product 30a and the offcut 30b are connected only by one joint portion J. The joint portion J is formed between the cut groove 331 and the cut groove 335 in the X-axis direction.

For this reason, the product 30a can be collected from the workpiece 30 in a state in which cutting with the laser machining apparatus 100 is completed simply by removing one joint portion J, which facilitates the collection of the product 30a.

The joint portion J is formed in a quadrangular prism shape. The length of the joint portion J along the X-axis direction is referred to as a joint portion width WJ, i.e. the width of the joint portion J. The X-axis direction is parallel to the extending direction of the cut groove 335 and is parallel to the joint portion machining direction in which the joint portion J is produced. The length of the joint portion J along the Y-axis direction is referred to as a joint portion depth DJ, i.e. the depth of the joint portion J. The dimension of the joint portion depth DJ is the same as the dimension of the groove width of the cut groove 33. The length of the joint portion J in the thickness direction of the workpiece 30, that is, the length of the joint portion J along the Z-axis direction, is referred to as a joint portion height HJ, i.e. the height of the joint portion J. The height direction of the joint portion J is parallel to the thickness direction of the workpiece 30, that is, the plate thickness direction of the workpiece 30. The joint portion height HJ can be rephrased as the joint portion thickness, i.e. the thickness of the joint portion J.

The joint portion J is formed from the position of a lower surface 32 of the workpiece 30 to an intermediate position between the upper surface 31 of the workpiece 30 and the lower surface 32 of the workpiece 30 in the thickness direction of the workpiece 30. The lower surface 32 of the workpiece 30 faces a direction that is opposite to a direction the irradiation surface faces. That is, the dimension of the joint portion height HJ is smaller than the dimension of the workpiece thickness T. In the thickness direction of the workpiece 30, that is, in the height direction of the joint portion J, the height position of an upper surface JI of the joint portion J is lower than the height position of the upper surface 31 of the workpiece 30. The upper surface JI of the joint portion J is the surface on aside of the machining head 13 and on a side of the upper surface 31 of the workpiece 30 among a pair of surfaces of the joint portion J facing each other in the thickness direction of the joint portion J.

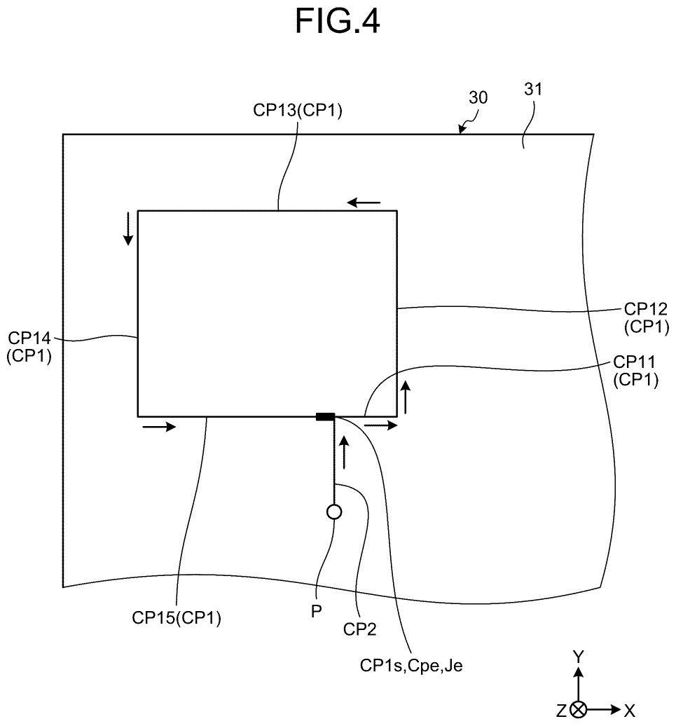

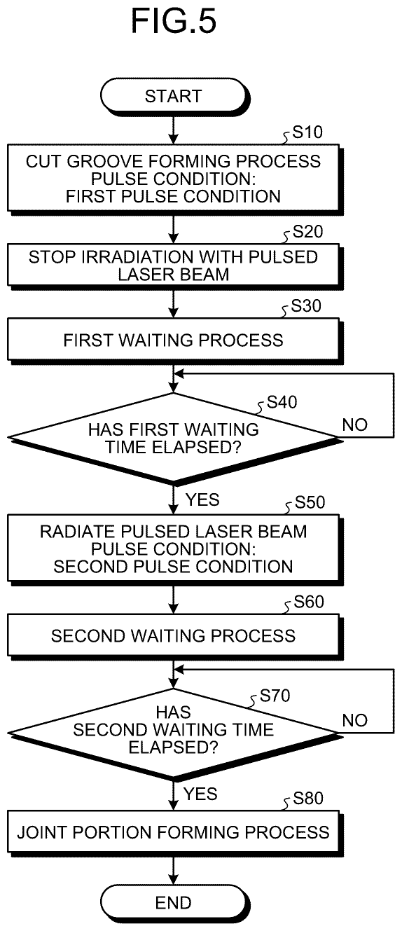

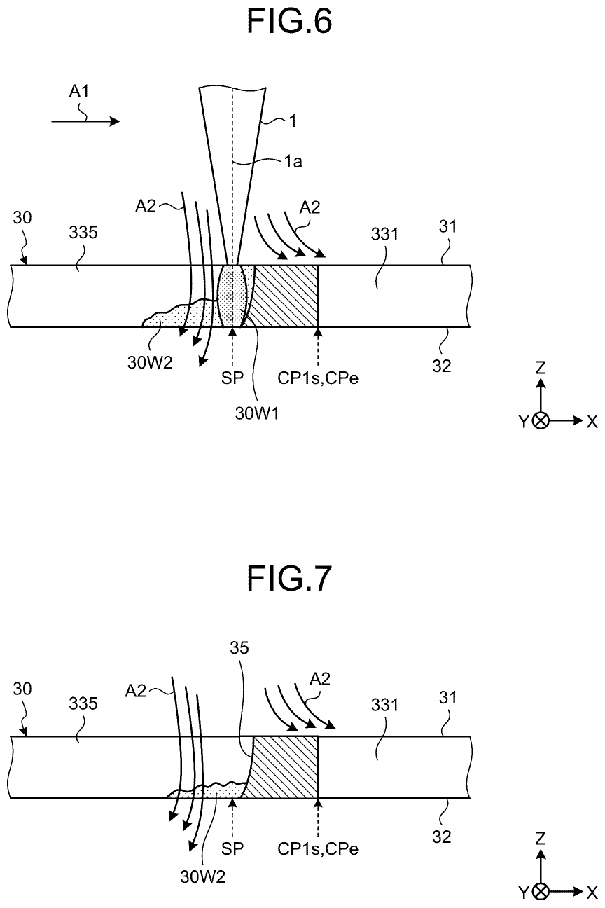

Next, a method of cutting the workpiece 30 with the laser machining apparatus 100 will be described. FIG. 4 is a plan view for explaining a method of cutting the workpiece 30 with the laser machining apparatus 100 illustrated in FIG. 1. FIG. 5 is a flowchart illustrating a procedure for the method of cutting the workpiece 30 with the laser machining apparatus 100 illustrated in FIG. 1. FIGS. 6 to 11 are schematic cross-sectional views for explaining the method of cutting the workpiece 30 with the laser machining apparatus 100 illustrated in FIG. 1. FIGS. 6 to 11 depict longitudinal sections of the workpiece 30 passing through the cut groove 331 and the cut groove 335. In FIGS. 6 and 10, arrow A1 indicates the machining direction of the workpiece 30. The machining direction of the workpiece 30 can be rephrased as the moving direction of the machining head 13 and the moving direction of the pulsed laser beam 1. In FIGS. 6 to 11, arrows A2 indicate directions in which the machining gas 2 flows.

First, in step S10, as illustrated in FIG. 6, a cut groove forming process is performed. The cut groove forming process is a process in which the cut groove 33 is formed along a predetermined machining path CP so that the workpiece 30 is cut. Specifically, the control unit 16 performs control to cause the laser oscillator 11 to start emitting the pulsed laser beam 1 under a first pulse condition, and control to start ejection of the machining gas 2 from the gas nozzle 18. Then, the control unit 16 controls the drive unit 14 such that the irradiation position of the pulsed laser beam 1 on the upper surface 31 of the workpiece 30 moves along the machining path CP.

The first pulse condition is a pulse condition of the pulsed laser beam 1 for cut groove formation which is used in the cut groove forming process, and is a first laser beam condition. Hereinafter, the pulsed laser beam 1 emitted under the first pulse condition may be referred to as the first pulsed laser beam 1.

The drive unit 14 performs control to change the position of the machining head 13 and/or the workpiece 30 under the control of the control unit 16 such that the pulsed laser beam 1 travels along the machining path CP on the upper surface 31 of the workpiece 30. The first embodiment assumes that the drive unit 14 performs control such that the pulsed laser beam 1 travels on the upper surface 31 of the workpiece 30 along the machining path CP by moving the machining head 13 in the in-plane direction of the upper surface 31 of the workpiece 30, with the position of the workpiece 30 fixed.

The cut groove forming process in step S10 includes a piercing process. That is, the piercing hole P is opened by irradiating a predetermined position on the upper surface 31 of the workpiece 30 with the first pulsed laser beam 1. The piercing hole P is a through hole cut entirely through the workpiece 30 in the direction of the workpiece thickness T. After the piercing hole P is formed, the cut groove 33 is formed along the machining path CP. The arrows illustrated in FIG. 4 indicate the machining direction of the workpiece 30 during the formation of the cut groove 33 along the machining path CP. The machining direction of the workpiece 30 can be rephrased as the moving direction of the machining head 13, the moving direction of the pulsed laser beam 1, or the cutting direction.

The machining path CP includes a first machining path CP1 and a second machining path CP2. The first machining path CP1 is a machining path conforming to the outer shape of the product 30a in the in-plane direction of the upper surface 31 of the workpiece 30, and is a cutting path conforming to the outer shape of the product 30a in the in-plane direction of the upper surface 31 of the workpiece 30. The first machining path CP1 is a machining path composed of a machining path CP11 which is a machining path along the X-axis direction, a machining path CP12 which is a machining path along the Y-axis direction, a machining path CP13 which is a machining path along the X-axis direction, a machining path CP14 which is a machining path along the Y-axis direction, and a machining path CP15 which is a machining path along the X-axis direction, which are coupled in this order. The first machining path CP1 is continuously machined.

The second machining path CP2 is a cutting path connecting the piercing hole P and the first machining path CP1. The cutting in which the cut groove 33 is formed along the second machining path CP2 from the piercing hole P is successively followed by the cutting in which the cut groove 33 is formed along the first machining path CP1 from the intersection of the first machining path CP1 and the second machining path CP2. The cutting along the first machining path CP1 is performed in the counterclockwise direction.

Next, in step S20, as illustrated in FIG. 7, the irradiation of the irradiation surface of the workpiece 30 with the first pulsed laser beam 1 is stopped at a predetermined irradiation stop position SP which is a position just before a machining end point CPe. As illustrated in FIG. 4, the machining end point CPe on the machining path CP is the end point of machining on the machining path CP, and is located at the same position as a machining start point CPIs on the first machining path CP1.

The machining end point CPe on the machining path CP is located at the same position as an end Je of the joint portion J in the machining direction on the machining path CP15.

The irradiation stop position SP, which is a position just before the machining end point CPe, is a position immediately before the formation region of the joint portion J in the machining direction along the first machining path CP1, that is, a position adjacent to the formation region of the joint portion J in the cutting direction along the machining path CP15. The position just before the machining end point CPe is in other words a position just before the formation region of the joint portion J in the machining direction on the machining path CP15. In addition, the irradiation stop position SP can be rephrased as a machining condition change position at which the machining conditions for cutting of the workpiece 30 are changed, and can also be rephrased as a pulse condition change position at which the pulse condition of the pulsed laser beam 1 is changed. The formation region of the joint portion J is a region where the joint portion J is formed in the in-plane direction of the workpiece 30.

Specifically, the control unit 16 controls the laser oscillator 11 to stop the emission of the first pulsed laser beam 1. In addition, the control unit 16 controls the drive unit 14 to stop the movement of the machining head 13 from a position slightly before the irradiation stop position SP, so as to stop the movement of the machining head 13 at the irradiation stop position SP.

The control unit 16 performs control to stop the emission of the first pulsed laser beam 1 at the end of the cut groove forming process, that is, at the time when the irradiation position of the first pulsed laser beam 1 on the upper surface 31 of the workpiece 30 reaches the irradiation stop position SP on the first machining path CP1. The laser oscillator 11 stops the emission of the first pulsed laser beam 1 under the control of the control unit 16. The drive unit 14 stops the movement of the machining head 13 under the control of the control unit 16. Consequently, at the time when the irradiation position of the first pulsed laser beam 1 on the upper surface 31 of the workpiece 30 reaches the irradiation stop position SP on the first machining path CP1, the movement of the machining head 13 is stopped, and the irradiation of the irradiation surface with the first pulsed laser beam 1 is stopped.

On the other hand, in step S20, the ejection onto the irradiation surface of the machining gas 2 onto the irradiation surface is not stopped. That is, the control unit 16 does not perform control to stop the ejection of the machining gas 2 from the gas nozzle 18 onto the irradiation surface. Therefore, the machining gas 2 is continuously ejected onto the upper surface 31 of the workpiece 30 even after the irradiation of the upper surface 31 of the workpiece 30 with the first pulsed laser beam 1 is stopped.

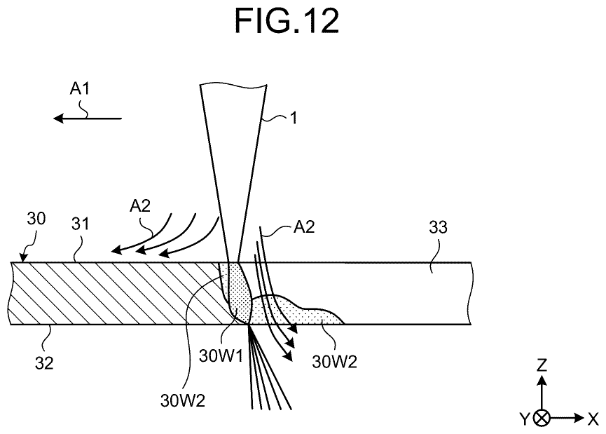

The laser machining of the workpiece 30 with the pulsed laser beam 1 proceeds mainly in two phenomena: a melting phenomenon in which the material of the workpiece 30 is melted by the pulsed laser beam 1; and a discharge phenomenon in which the melted material is discharged by the machining gas 2. When oxygen is used as the machining gas 2, the material of the workpiece 30 also undergoes an oxidation combustion reaction. The machining phenomena on the workpiece 30 with the pulsed laser beam 1 will be described. FIG. 12 is a cross-sectional view for explaining the concept of machining phenomena on the workpiece 30 with the pulsed laser beam 1.

FIG. 12 schematically depicts a situation in which the workpiece 30 is melted and discharged by running the pulsed laser beam 1 on the upper surface 31 of the workpiece 30. By irradiating the upper surface 31 of the workpiece 30 with the pulsed laser beam 1, the workpiece 30 is melted from around the upper surface 31. The material located below the portion around the upper surface 31 melted by the irradiation of the workpiece 30 with the pulsed laser beam 1 is melted by the energy of the pulsed laser beam 1 and the heat of the melt of the upper-portion material melted earlier. Consequently, a melt 30W1 in which the workpiece 30 is melted is formed. A part of the melt 30W1 is immediately blown off downward from the workpiece 30, that is, toward the lower surface 32 of the workpiece 30, by the machining gas 2 ejected onto the upper surface 31 of the workpiece 30, and is discharged from the workpiece 30.

Another part of the melt 30W1 flows toward the lower surface 32 of the workpiece 30 inside the cut groove 33, that is, flows toward the bottom of the cut groove 33, and becomes a melt 30W2. Then, the melt 30W2 is also blown off toward the lower surface 32 of the workpiece 30 by the machining gas 2 ejected onto the upper surface 31 of the workpiece 30, and is discharged from the workpiece 30. Such machining phenomena occur with the movement of the pulsed laser beam 1, whereby the cut groove 33, which is a through groove cut entirely through the workpiece 30 in the plate thickness direction, is formed with the movement of the pulsed laser beam 1, and the workpiece 30 is cut.

Next, in step S30, a first waiting process is performed over a predetermined first waiting time WT1. The first waiting process is a process of stopping the irradiation of the irradiation surface with the first pulsed laser beam 1 and waiting. The first waiting time WT1 is a waiting time for which the first waiting process is continued. Specifically, the control unit 16 continues the control performed in step S20. That is, in the first waiting process, the stop state of the emission of the first pulsed laser beam 1 and the movement stop state of the machining head 13 controlled in step S20 are continued, and the irradiation stop state of the first pulsed laser beam 1 on the irradiation surface is maintained. On the other hand, in the first waiting process, the ejection state of the machining gas 2 from the gas nozzle 18 onto the irradiation surface controlled in step S10 is maintained. That is, in steps S20 and S30, changes in the emission state of the first pulsed laser beam 1 and the movement state of the machining head 13 are controlled.

Therefore, in step S30, the phenomenon in which the material of the workpiece 30 is melted by the first pulsed laser beam 1 to form the cut groove 33, does not occur. On the other hand, in step S30, the phenomenon in which the material melted by the machining gas 2 is discharged from the workpiece 30, continuously occurs. That is, in step S30, with no further melting of the workpiece 30, the melt 30W2 that is a melted material of the workpiece 30 is discharged downward from the workpiece 30 by the machining gas 2 as illustrated in FIG. 7.

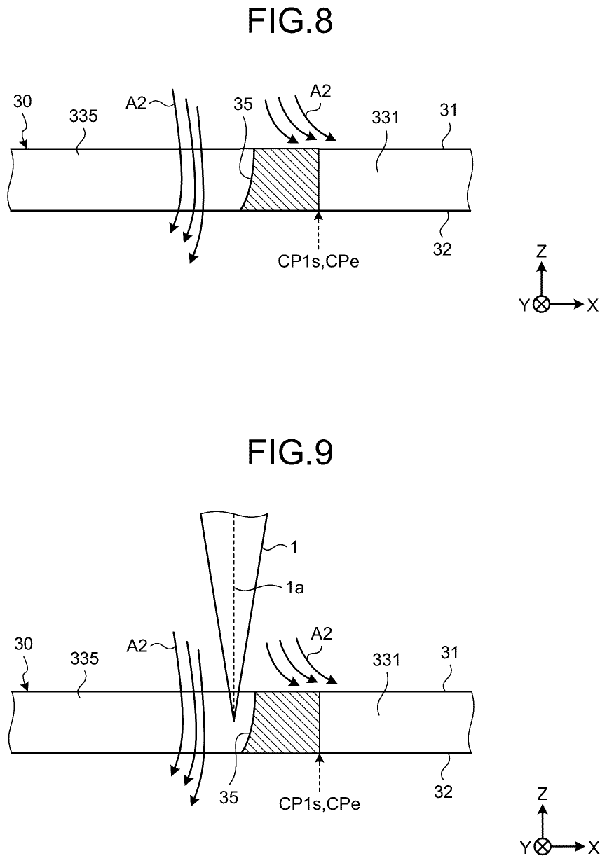

There is a slight time lag between the melting phenomenon and the discharge phenomenon described above. This means that immediately after the irradiation of the upper surface 31 of the workpiece 30 with the pulsed laser beam 1 is stopped, the melting phenomenon is completed but the discharge phenomenon is not completed for the material of the workpiece 30 melted by the time immediately before the irradiation of the pulsed laser beam 1 is stopped. Thus, in the laser machining apparatus 100, the first waiting process is performed over the predetermined first waiting time WT1, whereby the discharge phenomenon can be reliably completed for the material of the workpiece 30 melted by the time immediately before the irradiation of the irradiation surface with the first pulsed laser beam 1 is stopped, as illustrated in FIG. 8. Consequently, the cut groove 33 formed at the position immediately before the formation region of the joint portion J in the machining direction along the first machining path CP1, that is, the irradiation stop position SP of the first pulsed laser beam 1, is prevented from being blocked by the melt.

That is, in the laser machining apparatus 100, the first waiting process is performed over the predetermined first waiting time WT1. Therefore, the melt 30W2, which has been melted by the time immediately before the irradiation with the first pulsed laser beam 1 is stopped and has flowed toward the lower surface 32 of the workpiece 30, can be discharged downward from the workpiece 30, thereby the cutting machining path along the first machining path CP1 can be cut completely through the workpiece 30 in the thickness direction. Consequently, in the laser machining apparatus 100, the cut groove 33 can be formed at a desired position along the first machining path CP1 in the workpiece 30, and the region irradiated with the first pulsed laser beam 1 on the first machining path CP1 can be reliably cut out. In other words, the first waiting process is performed in order to completely end the removal, from the workpiece 30, of the material of the workpiece 30 melted by the time immediately before the irradiation of the irradiation surface with the first pulsed laser beam 1 is stopped.

As described above, in the laser machining apparatus 100, by appropriately discharging melt from the cut groove 33 with the machining gas 2, it is possible to prevent blow-up of spatter scattering from the molten portion of the workpiece 30. If the discharge of melt from the cut groove 33 with the machining gas 2 is not appropriately performed and the machining proceeds to the formation of the joint portion J, there is a possibility that contamination or damage due to blow-up of spatter may occur in the optical system including the machining lens and the protective glass provided in the machining head 13, and in the nozzles such as the beam nozzle 17 and the gas nozzle 18. In the laser machining apparatus 100, by appropriately discharging melt from the cut groove 33 with the machining gas 2, it is possible to prevent blow-up of spatter scattering from the molten portion of the workpiece 30. Then, in the laser machining apparatus 100, it is possible to prevent machining defects in the workpiece 30 to be cut next due to contamination or damage of components caused by blow-up of spatter.

In contrast, if the first waiting process is not performed, the melt that has been melted immediately before the irradiation with the first pulsed laser beam 1 is stopped and has flowed toward the lower surface 32 of the workpiece 30 inside the cut groove 33, cannot be completely discharged from the cut groove 33. That is, the melt 30W2 illustrated in FIG. 7, which has flowed toward the bottom of the cut groove 33 inside the cut groove 33, cannot be completely discharged from the cut groove 33.

With the melt 30W2 left in the cut groove 33, if the formation of the joint portion J is started by radiating the second pulsed laser beam 1 as described later, the second pulsed laser beam 1 is reflected by the melt 30W2. A part of the reflected second pulsed laser beam 1 hits a side surface 35 of the workpiece 30 facing the machining path CP15 in the machining direction on the machining path CP15. In this case, because the side surface 35 of the workpiece 30 hit by the reflected second pulsed laser beam 1 is scratched, the periphery of the side surface 35 cannot be melted in a manner consistent with the setting at the time of forming the joint portion J, and the balance between melting and melt discharge is lost.

Therefore, without the first waiting process, the second pulsed laser beam 1 that has hit the melt 30W2 is reflected to hit the side surface 35 of the workpiece 30, which adversely affects the formation of the joint portion J and results in an uneven balance between melting and melt discharge.

In step S40, it is determined whether the first waiting time WT1 has elapsed. Specifically, the control unit 16 determines whether the first waiting time WT1 has elapsed. The control unit 16 determines whether the first waiting time WT1 has elapsed using the timer function provided in the control unit 16.

When it is determined that the first waiting time WT1 has not elapsed, the determination in step S40 becomes No and step S40 is repeated. When it is determined that the first waiting time WT1 has elapsed, the determination in step S40 becomes Yes and the procedure proceeds to step S50.

In step S50, as illustrated in FIG. 9, the workpiece 30 is irradiated with the pulsed laser beam 1 under a second pulse condition replacing the pulse condition of the pulsed laser beam 1 in the cut groove forming process.

The second pulse condition is a pulse condition of the pulsed laser beam 1 for forming the joint portion J which is used in the joint portion forming process, and is a second laser beam condition. The second pulse condition is a pulse condition of the pulsed laser beam 1 replacing the pulse condition of the first pulsed laser beam 1, which is the first pulse condition The second pulse condition is different from the first pulse condition. Hereinafter, the pulsed laser beam 1 emitted under the second pulse condition may be referred to as the second pulsed laser beam 1.

The second pulse condition differs from the first pulse condition in the output of the pulsed laser beam 1, the frequency of the pulsed laser beam 1, and the duty ratio of the pulsed laser beam 1. Other pulse conditions in the second pulse condition are the same as those in the first pulse condition. In the second pulse condition, the output of the pulsed laser beam 1, the frequency of the pulsed laser beam 1, and the duty ratio of the pulsed laser beam 1 are all set to be lower than those in the first pulse condition. Therefore, the second pulsed laser beam 1 gives less thermal energy to the workpiece 30 per unit time than the first pulsed laser beam 1.

Specifically, the control unit 16 performs control to cause the laser oscillator 11 to start emitting the pulsed laser beam 1 under the second pulse condition that is different from the first pulse condition of the pulsed laser beam 1 in the cut groove forming process. At this time, because the control unit 16 does not control the drive unit 14, the machining head 13 does not move. The ejection of the machining gas 2 from the gas nozzle 18 is continued.

Therefore, the emission of the second pulsed laser beam 1 under the second pulse condition is started while the machining gas 2 is not ejected and the machining head 13 is not moved. At this point, the second pulsed laser beam 1 is radiated to the irradiation stop position SP at which the irradiation with the first pulsed laser beam 1 stopped in step S20, that is, radiated to a part near the end inside the cut groove 33, and thus does not hit the upper surface 31 of the workpiece 30.

Next, in step S60, a second waiting process is performed over a predetermined second waiting time WT2. The second waiting process is a process of waiting until the second pulsed laser beam 1 is stably emitted from the laser oscillator 11 under the set second pulse condition and radiated to the workpiece 30. Thus, the second waiting process is in other words a process of stabilizing the second pulsed laser beam 1. The second waiting time WT2 is a waiting time for which the second waiting process is continued, and is in other words a time for stabilization of the second pulsed laser beam 1.

Specifically, the control unit 16 continues the control performed in step S50. That is, in the second waiting process, the irradiation state of the second pulsed laser beam 1 controlled in step S50 is maintained. On the other hand, in the second waiting process, the control of starting the ejection of the machining gas 2 from the gas nozzle 18 and the control of the drive unit 14 are not performed. Therefore, in the second waiting process, the irradiation state of the second pulsed laser beam 1 is maintained while the machining gas 2 is ejected and the machining head 13 is not moved.

Immediately after the pulsed laser beam 1 is radiated from the laser oscillator 11 that has been in a stop state, there is a transition period that lasts until the state of the pulsed laser beam 1 is stabilized under the set pulse condition. In the transition period, the state of the pulsed laser beam 1 is not stable in the set pulse condition; for example, the output of the pulsed laser beam 1 has not yet increased to the set value, or the pulse waveform of the pulsed laser beam 1 is not consistent with the setting.

If the joint portion J is formed using the pulsed laser beam 1 in this transition period, the melting of the material of the workpiece 30 is not stabilized at the formation start portion of the joint portion J in the formation region of the joint portion J. Consequently, the failure occurs in that, in the formation region of the joint portion J, the melting length from the upper surface 31 of the workpiece 30 that is a joint portion melting length LM, cannot be obtained so as to fall within required dimension consistent with the setting. That is, forming the joint portion J using the pulsed laser beam 1 in the transition period results in the failure in that the joint portion J having a shape consistent with the setting cannot be obtained.

The joint portion melting length LM is the depth by which the workpiece 30 is melted from the upper surface 31 of the workpiece 30 during the formation of the joint portion J in the direction of the workpiece thickness T, and is the melting depth of the workpiece 30 from the upper surface 31 of the workpiece 30. That is, the joint portion melting length LM is the length, in the thickness direction of the workpiece 30, of the portion where the workpiece 30 is melted and removed during the formation of the joint portion J. As illustrated in FIG. 3, the joint portion melting length LM is the length from the upper surface 31 of the workpiece 30 to the upper surface J1 of the joint portion J in the thickness direction of the workpiece 30.

Therefore, in the laser machining apparatus 100, in order to avoid the occurrence of the above failure, the second waiting process is provided immediately after the pulsed laser beam 1 is radiated from the laser oscillator 11 that has been in a stop state, and after the pulsed laser beam 1 is stabilized under the second pulse condition, machining to form the joint portion J is performed.

In step S70, it is determined whether the second waiting time WT2 has elapsed. Specifically, the control unit 16 determines whether the second waiting time WT2 has elapsed. The control unit 16 determines whether the second waiting time WT2 has elapsed using the timer function provided in the control unit 16.

When it is determined that the second waiting time WT2 has not elapsed, to the determination becomes No in step S70 and step S70 is repeated. When it is determined that the second waiting time WT2 has elapsed, to the determination becomes Yes in step S70 and the procedure proceeds to step S80.

In step S80, as illustrated in FIG. 10, the joint portion J is formed. Specifically, the control unit 16 controls the drive unit 14 such that the irradiation position of the second pulsed laser beam 1 on the upper surface 31 of the workpiece 30 moves along the machining path CP15.

Then, at the time when the irradiation position

of the second pulsed laser beam 1 reaches the position of the machining end point CPe, which is the machining end point on the machining path CP, the control unit 16 performs control to stop the emission of the second pulsed laser beam 1 and stop the irradiation of the upper surface 31 of the workpiece 30 with the second pulsed laser beam 1. That is, the control unit 16 performs control to cause the second pulsed laser beam 1 to run from the irradiation stop position SP, which is a position just before the machining end point CPe on the first machining path CP1 described above, to the position of the machining end point CPe. The region from the irradiation stop position SP to the position of the machining end point CPe on the first machining path CP1, which is the region of the workpiece 30 in which the second pulsed laser beam 1 runs, is an uncut region where the cut groove 33 is not formed on the machining path CP. The uncut region can be rephrased as the region from the irradiation stop position SP, which is a position short of the machining end point CPe on the first machining path CP1, to the start point of the first machining path CP1. The start point of the first machining path CP1 is the start point of the first machining path CP1, which is a machining path conforming to the outer shape of the product 30a in the in-plane direction of the upper surface 31 of the workpiece 30, and is different from the start point of the machining path CP including the second machining path CP2.

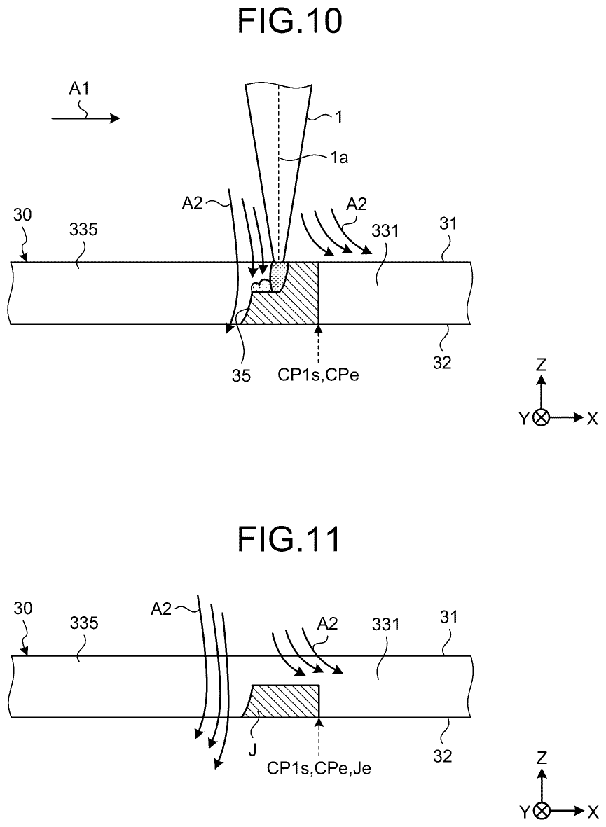

Consequently, as illustrated in FIG. 11, the workpiece 30 is machined by melting only a part of the formation region of the joint portion J of the workpiece 30 from the upper surface 31 of the workpiece 30 in the thickness direction of the workpiece 30, whereby the joint portion J can be formed. That is, here, the portion of the workpiece 30 irradiated with the second pulsed laser beam 1 is not entirely melted in the direction of the workpiece thickness T. In addition, the control unit 16 performs control to stop the ejection of the machining gas 2 at the time when the irradiation position of the second pulsed laser beam 1 reaches the position of the machining end point CPe, which is the machining end point on the machining path CP. That is, the control unit 16 performs control to stop the ejection of the machining gas 2 at the same timing as the timing of performing control to stop the ejection of the second pulsed laser beam 1. Note that after the control unit 16 performs control to stop the ejection of the machining gas 2, there is a time lag until the ejection of the machining gas 2 completely stops. According to such control, the melt melted by the

time immediately before the irradiation of the second pulsed laser beam 1 is stopped, can be completely discharged from the cut groove 33 and the upper surface J1 of the joint portion J, and the cut groove 33 and the joint portion J having the designed shapes are formed. Then, by performing machining with the second pulsed laser beam 1 until reaching the machining end point CPe, the joint portion J is formed such that the thickness of the joint portion J is smaller than the plate thickness of the workpiece 30 in the thickness direction of the workpiece 30.

Here, in the second pulse condition, the output of the pulsed laser beam 1, the frequency of the pulsed laser beam 1, and the duty ratio of the pulsed laser beam 1 are all set to be lower than those in the first pulse condition. Therefore, the energy supplied per unit area of the upper surface 31 of the workpiece 30 by the pulsed laser beam 1 under the second pulse condition at the time of forming the joint portion J is lower than the energy supplied per unit area of the upper surface 31 of the workpiece 30 by the pulsed laser beam 1 under the first pulse condition in the cut groove forming process. That is, the second pulsed laser beam 1 gives less thermal energy to the workpiece 30 per unit time than the first pulsed laser beam 1.

The output of the pulsed laser beam 1, the frequency of the pulsed laser beam 1, and the duty ratio of the pulsed laser beam 1 are reduced at the time of forming the joint portion J. Given this situation, the moving speed of the machining head 13, that is, the moving speed of the pulsed laser beam 1, is also made lower than that in the cut groove forming process that uses the pulsed laser beam 1 under the first pulse condition, in order to reliably supply the energy required for melting the workpiece 30 to the workpiece 30. Consequently, the joint portion J can be precisely formed with a thickness in the thickness direction of the workpiece 30 that is smaller than the plate thickness of the workpiece 30.

Therefore, under the second pulse condition, the control of making the output of the pulsed laser beam 1, the frequency of the pulsed laser beam 1, and the duty ratio of the pulsed laser beam 1 lower than those in the first pulse condition and making the moving speed of the machining head 13 lower than that in the cut groove forming process is performed. It can be said that this control is control that enables precise and reliable formation of the joint portion J having a desired shape.

Here, while the output of the pulsed laser beam 1, the frequency of the pulsed laser beam 1, and the duty ratio of the pulsed laser beam 1 are reduced, the gas pressure of the machining gas 2 is not reduced.

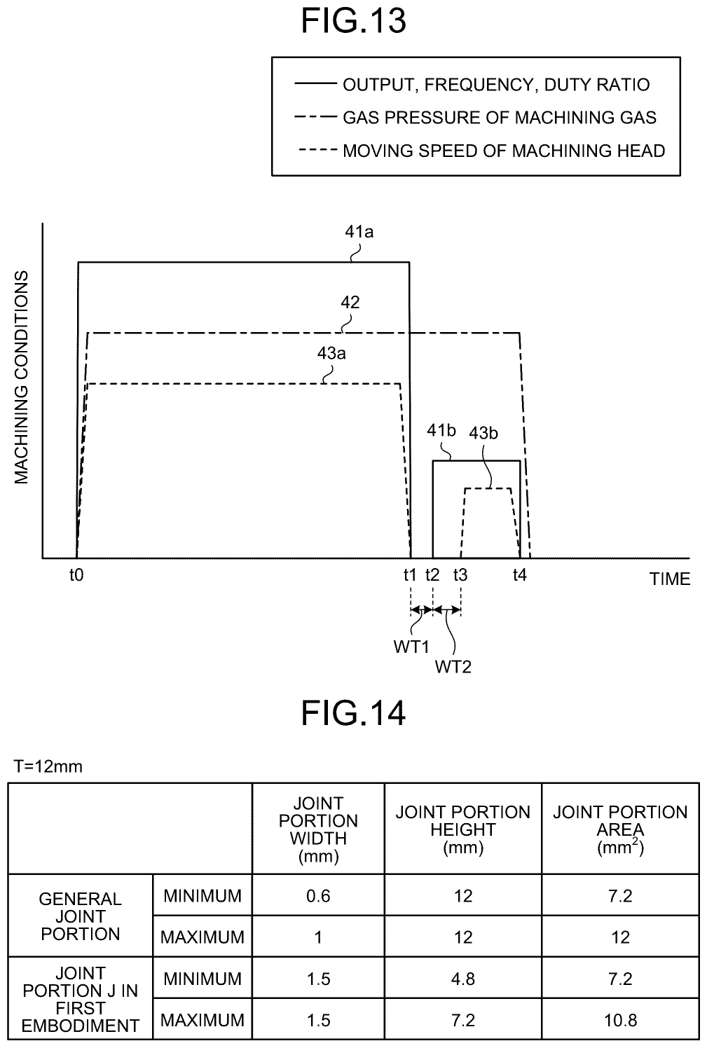

FIG. 13 is a time chart for the cutting of the workpiece 30 with the laser machining apparatus 100 illustrated in FIG. 1. The horizontal axis in FIG. 13 indicates time. The vertical axis in FIG. 13 indicates the magnitude of each machining condition. Solid line 41a in FIG. 13 indicates the output of the pulsed laser beam 1, the frequency of the pulsed laser beam 1, and the duty ratio of the pulsed laser beam 1 in the first pulse condition of the pulsed laser beam 1 at the time of cutting the workpiece 30. Solid line 41b in FIG. 13 indicates the output of the pulsed laser beam 1, the frequency of the pulsed laser beam 1, and the duty ratio of the pulsed laser beam 1 in the second pulse condition of the pulsed laser beam 1.

In the cutting of the workpiece 30, the output of the pulsed laser beam 1, the frequency of the pulsed laser beam 1, and the duty ratio of the pulsed laser beam 1 change as indicated by solid line 41a or solid line 41b in FIG. 13. That is, in the cutting of the workpiece 30, the output of the pulsed laser beam 1, the frequency of the pulsed laser beam 1, and the duty ratio of the pulsed laser beam 1 are all set to mutually different conditions in the cut groove forming process and the joint portion forming process, such that the set values in the joint portion forming process are smaller than the set values in the cut groove forming process.

Dashed-dotted line 42 in FIG. 13 indicates the gas pressure of the machining gas 2, among the machining conditions at the time of cutting the workpiece 30. The gas pressure of the machining gas 2 in the cutting of the workpiece 30 is set to a predetermined constant value from the start of cutting until the end of cutting, and is not changed during the cutting.

Broken line 43a in FIG. 13 indicates the moving speed of the machining head 13 in the cut groove forming process, that is, the moving speed of the pulsed laser beam 1 in the cut groove forming process, among the machining conditions at the time of cutting the workpiece 30.

Broken line 43b in FIG. 13 indicates the moving speed of the machining head 13 in the joint portion forming process, that is, the moving speed of the pulsed laser beam 1 in the joint portion forming process, among the machining conditions at the time of cutting the workpiece 30.

In the cutting of the workpiece 30 with the laser machining apparatus 100, step S10 is started at time to as illustrated in FIG. 13. Steps S20 and S30 are started at time t1. Steps S50 and S60 are performed at time t2. Step S80 is performed at time t3. Then, the cutting of the workpiece 30 ends at time t4.

Here, a specific length of the first waiting time WT1 will be described. In the first embodiment, the first waiting time WT1 is 0.1 seconds or more. The inventors conducted an experiment in which a plurality of workpieces 30 were cut by changing only the first waiting time WT1 among the machining conditions, and examined which time is suitable as the first waiting time WT1.

As a result of the experiment, the inventors have found that with the first waiting time WT1 of 0 seconds, that is, without the first waiting time WT1, the material of the workpiece 30 cannot be reliably melted as designed around the formation start portion of the joint portion J, and the required joint portion melting length LM cannot be obtained. That is, the inventors have found that the required joint portion height HJ cannot be obtained with the first waiting time WT1 of 0 seconds.

This is because the melt 30W2 remains at the bottom of the cut groove 33 at the start of formation of the joint portion J, and thus, as described above, a part of the second pulsed laser beam 1 reflected by the melt 30W2 hits the side surface 35 of the workpiece 30. Here, “around the formation start portion of the joint portion J” means “around the side surface 35 of the workpiece 30”.

In addition, the inventors have found that even with the first waiting time WT1 of 0.05 seconds, the material of the workpiece 30 cannot be reliably melted as designed around the formation start portion of the joint portion J, and the required joint portion melting length LM cannot be obtained. That is, the inventors have found that the required joint portion height HJ cannot be obtained even with the first waiting time WT1 of 0.05 seconds.

This is because the discharge of the melt 30W2 from the bottom of the cut groove 33 is insufficient at the start of formation of the joint portion J, and thus, as described above, a part of the second pulsed laser beam 1 reflected by the melt 30W2 hits the side surface 35 of the workpiece 30. However, with the first waiting time WT1 of 0.05 seconds, the joint portion J has a shape closer to the design shape than with the first waiting time WT1 of 0 seconds.

In addition, the inventors have found that with the first waiting time WT1 of 0.1 seconds, the material of the workpiece 30 can be reliably melted as designed around the formation start portion of the joint portion J, and the required joint portion melting length LM can be obtained. That is, the inventors have found that with the first waiting time WT1 of 0.1 seconds, the required joint portion height HJ is obtained, and the joint portion J having the designed shape is obtained.

This is because, with the first waiting time WT1 of 0.1 seconds, the melt 30W2 at the bottom of the cut groove 33 is completely discharged from the cut groove 33, and no adverse effect occurs due to a part of the second pulsed laser beam 1 reflected by the melt 30W2 and hitting the side surface 35 of the workpiece 30. In addition, with the first waiting time WT1 longer than 0.1 seconds, the same result was obtained as with the first waiting time WT1 of 0.1 seconds.

Given the above, in order to completely discharge the melt 30W2 at the bottom of the cut groove 33 from the cut groove 33 to obtain the joint portion J having the designed shape, it is necessary to set the first waiting time WT1 to 0.1 seconds or more.

Next, a specific length of the second waiting time WT2 will be described. In the first embodiment, the second waiting time WT2 is 0.1 seconds or more. The inventors conducted an experiment in which a plurality of workpieces 30 were cut by changing only the second waiting time WT2 among the machining conditions, and examined which time is suitable as the second waiting time WT2.

As a result of the experiment, the inventors have found that with the second waiting time WT2 of 0 seconds, that is, without the second waiting time WT2, the joint portion J chips around the formation start portion of the joint portion J, and the required joint portion width WJ cannot be obtained. That is, the inventors have found that the joint portion J having the required shape cannot be obtained with the second waiting time WT2 of 0 seconds.

This is because the second pulsed laser beam 1 is not stably emitted from the laser oscillator 11 under the set second pulse condition at the start of formation of the joint portion J.

In addition, the inventors have found that even

with the second waiting time WT2 of 0.05 seconds, the joint portion J chips around the formation start portion of the joint portion J, and the required joint portion width WJ cannot be obtained. That is, the inventors have found that the joint portion J having the required shape cannot be obtained with the second waiting time WT2 of 0.05 seconds.

This is because the second pulsed laser beam 1 is not stably emitted from the laser oscillator 11 under the set second pulse condition at the start of formation of the joint portion J.

In addition, the inventors have found that with the second waiting time WT2 of 0.1 seconds, the joint portion J does not chip around the formation start portion of the joint portion J, and the required joint portion width WJ can be obtained. That is, the inventors have found that the joint portion J having the designed shape can be obtained with the second waiting time WT2 of 0.1 seconds.

This is because, with the second waiting time WT2 of 0.1 seconds, the second pulsed laser beam 1 is stably emitted from the laser oscillator 11 under the set second pulse condition at the start of formation of the joint portion J. In addition, with the second waiting time WT2 longer than 0.1 seconds, the same result was obtained as with the second waiting time WT2 of 0.1 seconds.

Given the above, in order to obtain the joint portion J having the designed shape without generating a chip in the joint portion J around the formation start portion of the joint portion J, it is necessary to set the second waiting time WT2 to 0.1 seconds or more.

FIG. 14 is a diagram illustrating examples of dimensions of the joint portion J formed in the cutting of the workpiece 30 with the laser machining apparatus 100 illustrated in FIG. 1. FIG. 14 illustrates the dimensions of the joint portion J suitable for keeping the product 30a and the offcut 30b coupled when given the workpiece thickness T of 12 mm. Here, the material of the workpiece 30 is SS400, a kind of rolled steel sheet for general structure. The weight of the product 30a is 0.5 kg.

From the viewpoint of preventing the product 30a from being detached from the offcut 30b, the joint portion J needs to have a certain size in order to keep the product 30a coupled to the offcut 30b. Meanwhile, the joint portion J that is too large is not preferable for finally breaking the joint portion J and removing the product 30a from the offcut 30b.

According to the inventors' knowledge, when using a general joint portion, the joint portion height HJ of which is equal to the workpiece thickness T, it is preferable to set the joint portion width WJ that is about 1.5 to 2.5 times larger than the groove width of the cut groove 33 in order to prevent the product 30a from being detached from the offcut 30b. In this case, for example, given the workpiece thickness T of 12 mm and the groove width of the cut groove 33 of 0.4 mm, it is preferable to set the joint portion width WJ to 0.6 mm to 1.0 mm. For these dimensional conditions, because the joint portion height HJ is equal to the workpiece thickness T, namely 12 mm, a joint portion area HA is 7.2 mm² to 12 mm².

The joint portion area HA is the area of a longitudinal section of the joint portion J along the joint portion width WJ and the joint portion height HJ. The joint portion area HA can be calculated by the calculation formula “joint portion width WJ×joint portion height HJ”. The joint portion area HA corresponds to the area of the hatched portion in FIG. 3 and corresponds to the area of a cross section of the joint portion J along the XZ plane.

On the other hand, in the example of the joint portion J according to the first embodiment, the joint portion width WJ is fixed to 1.5 mm as shown in FIG. 14.

For obtaining the joint portion J according to the first embodiment to have the same joint portion area HA and the same mechanical strength as those of a general joint portion having the joint portion height HJ that is equal to the workpiece thickness T and the joint portion width WJ of 0.6 mm, the joint portion height HJ should be 40% or more of the workpiece thickness T. That is, in the laser machining method according to the first embodiment, the joint portion melting length LM should be 60% or less of the workpiece thickness T.

In addition, by setting the joint portion height HJ to 60% or less of the workpiece thickness T, the joint portion J according to the first embodiment has a slightly smaller joint portion area HA and achieves a slightly smaller mechanical strength than a general joint portion with the joint portion height HJ equal to the workpiece thickness T and the joint portion width WJ of 1.0 mm.

That is, by setting the joint portion height HJ to 40% or more of the workpiece thickness T, the joint portion J according to the first embodiment can secure the minimum joint portion area HA of a general joint portion with the joint portion height HJ equal to the workpiece thickness T, and thus can prevent the product 30a from falling off the offcut 30b.

In addition, by setting the joint portion height HJ to 60% or less of the workpiece thickness T, the joint portion J according to the first embodiment achieves the joint portion area HA slightly smaller than the maximum joint portion area HA of a general joint portion with the joint portion height HJ equal to the workpiece thickness T, which facilitates the post-processing of finally breaking the joint portion and removing the product 30a from the offcut 30b.

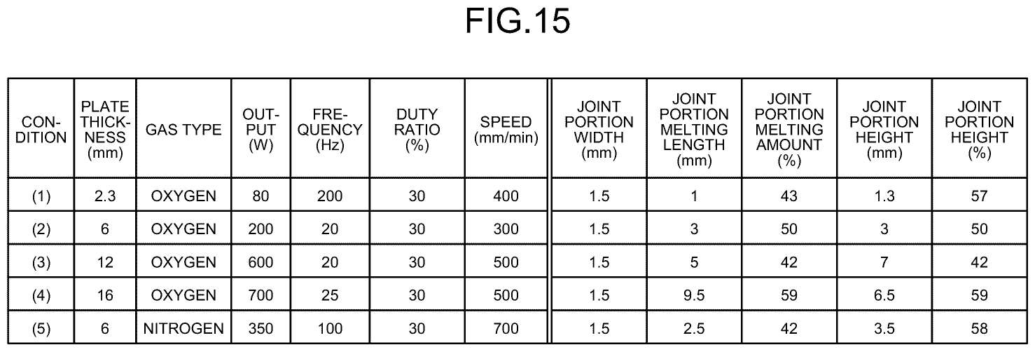

FIG. 15 is a diagram illustrating examples of machining conditions and dimensions of the joint portion J in the cutting of the workpiece 30 with the laser machining apparatus 100 illustrated in FIG. 1. In FIG. 15, “plate thickness” indicates the thickness of the workpiece 30, namely the workpiece thickness T. “Gas type” indicates the type of the machining gas 2. “Output” indicates the output of the pulsed laser beam 1. “Frequency” indicates the frequency of the pulsed laser beam 1. “Duty ratio” indicates the duty ratio of the pulsed laser beam 1. “Speed” indicates the moving speed of the machining head 13, i.e. the moving speed of the pulsed laser beam 1. “Joint portion melting amount (%)” is the ratio of the joint portion melting length LM to the plate thickness. “Joint portion height (%)” is the ratio of the joint portion height HJ to the plate thickness. Note that the conditions shown in FIG. 15 are also based on the premise that the groove width of the cut groove 33 is 0.4 mm.

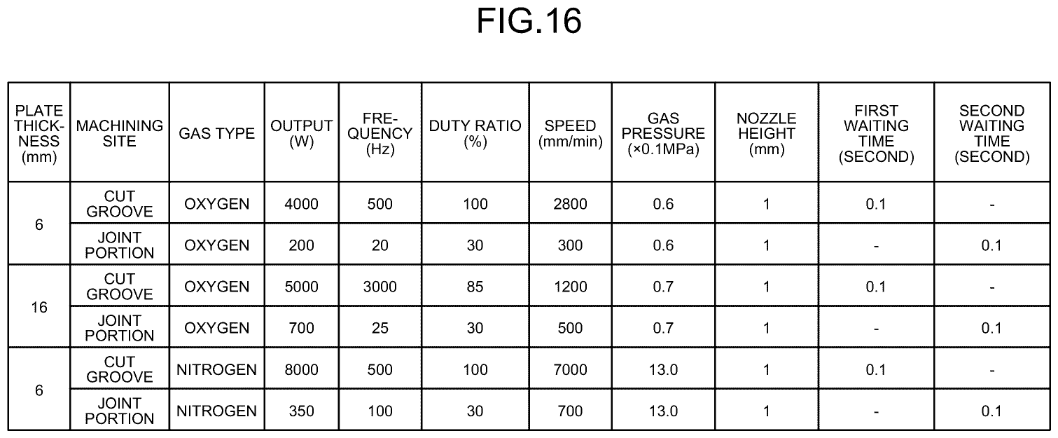

FIG. 16 is a diagram illustrating detailed machining conditions for cutting under conditions (2), (4), and (5) in the examples illustrated in FIG. 15. In FIG. 16, “gas pressure” indicates the pressure of the machining gas 2. “Nozzle height” indicates the height of the beam nozzle 17 and the gas nozzle 18 from the upper surface 31 of the workpiece 30.

As shown in FIG. 16, the output of the pulsed laser beam 1, the frequency of the pulsed laser beam 1, and the duty ratio of the pulsed laser beam 1 for producing the joint portion J are lower than the output of the pulsed laser beam 1, the frequency of the pulsed laser beam 1, and the duty ratio of the pulsed laser beam 1 for producing the cut groove 33. The first waiting time WT1 and the second waiting time WT2 are each 0.1 seconds.

As shown in FIG. 15, in the joint portion J, the joint portion melting length LM is 40% to 60% of the workpiece thickness T, and the joint portion height HJ is 40% to 60% of the workpiece thickness T. The joint portion J formed under such conditions can prevent the product 30a from being detached from the offcut 30b, and facilitates the post-processing of finally breaking the joint portion and removing the product 30a from the offcut 30b.

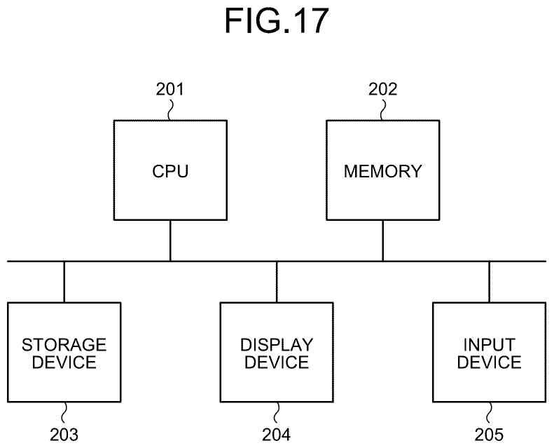

FIG. 17 is a diagram illustrating a hardware configuration for implementing the functions of the control unit 16 illustrated in FIG. 1. As illustrated in FIG. 17, the functions of the control unit 16 of the laser machining apparatus 100 are implemented by a control device including a central processing unit (CPU) 201, a memory 202, a storage device 203, a display device 204, and an input device 205. The functions that are executed by the control unit 16 are implemented by software, firmware, or a combination of software and firmware. Software or firmware is described as computer programs and stored in the storage device 203. The CPU 201 implements the functions of the control unit 16 by reading software or firmware stored in the storage device 203 into the memory 202 and executing the software or firmware. That is, the computer system includes the storage device 203 for storing programs that result in execution of the step of performing the operation of the control unit 16 described in the first embodiment when the functions of the control unit 16 are executed by the CPU 201. It can also be said that these programs cause a computer to execute the processes that the functions of the control unit 16 implement. The memory 202 is a volatile storage area such as a random access memory (RAM). The storage device 203 is a nonvolatile or volatile semiconductor memory such as a read only memory (ROM) or a flash memory, or a magnetic disk. Specific examples of the display device 204 include a monitor and a display. Specific examples of the input device 205 include a keyboard, a mouse, and a touch panel.

The laser machining apparatus 100 according to the first embodiment described above forms only one joint portion J when cutting the workpiece 30 along the contour of the product 30a. Consequently, in the laser machining apparatus 100, as compared with the case of forming a plurality of joint portions J, cutting is easily controlled by the control unit 16, and machining path programs can be easily created for use in the control of cutting by the control unit 16. In the cutting of the workpiece 30 with the laser machining apparatus 100, in which only one joint portion J is formed, the post-processing of finally breaking the joint portion J and removing the product 30a from the offcut 30b is facilitated, and the production efficiency of the cutting of the workpiece 30 is improved.

For forming a plurality of joint portions in the cutting of one product 30a, heat is gradually accumulated in the workpiece 30 as the cutting progresses, and a plurality of joint portions formed under the same machining conditions cannot have the same shape. For this reason, for forming a plurality of joint portions in the cutting of one product 30a, it is difficult to set appropriate machining conditions.

On the other hand, in the laser machining apparatus 100, in which only one joint portion J is formed when the workpiece 30 is cut, it is easy to set appropriate machining conditions.

In addition, in the laser machining apparatus 100, in the thickness direction of the workpiece 30, that is, in the height direction of the joint portion J, the joint portion J is formed with the height position of the upper surface J1 of the joint portion J lower than the height position of the upper surface 31 of the workpiece 30, and with the thickness of the joint portion J in the thickness direction of the workpiece 30 smaller than the plate thickness of the workpiece 30. Consequently, in the cutting of the workpiece 30 with the laser machining apparatus 100, the post-processing of finally breaking the joint portion J and removing the product 30a from the offcut 30b is facilitated, and the production efficiency of the cutting of the workpiece 30 is improved. That is, the laser machining apparatus 100 can form the joint portion J that facilitates the removal of the product 30a in the post-process after cutting.

In addition, in the laser machining apparatus 100, at the end of the cut groove forming process, the irradiation of the irradiation surface of the workpiece 30 with the first pulsed laser beam 1 and the movement of the machining head 13 are temporarily stopped. Then, after the end of the cut groove forming process, the first waiting process is performed over the first waiting time WT1. In the first waiting process, the machining gas 2 is ejected onto the irradiation surface while the ejection of the first pulsed laser beam 1 and the movement of the machining head 13 are stopped. Therefore, in the first waiting process, with no further melting of the material of the workpiece 30, the melt 30W2 that has been melted by the time immediately before the irradiation with the first pulsed laser beam 1 is stopped and has flowed toward the lower surface 32 of the workpiece 30 inside the cut groove 33, is discharged from the cut groove 33 by the machining gas 2. Consequently, the laser machining apparatus 100 can discharge, from the cut groove 33, all the material of the workpiece 30 melted by the time immediately before the irradiation of the irradiation surface of the workpiece 30 with the first pulsed laser beam 1 is stopped.

Therefore, the laser machining apparatus 100 can prevent an adverse effect on the formation of the joint portion J, the adverse effect being caused due to the second pulsed laser beam 1 reflected by the melt 30W2 remaining inside the cut groove 33 at the start of formation of the joint portion J and hitting the side surface 35 of the workpiece 30. Consequently, in the laser machining apparatus 100, the joint portion width WJ and the joint portion melting length LM can be obtained as designed, and the joint portion J having the designed shape can be obtained.

In addition, in the laser machining apparatus 100, by appropriately discharging melt from the cut groove 33 with the machining gas 2, it is possible to prevent blow-up of spatter scattering from the molten portion of the workpiece 30. Therefore, it is possible to prevent contamination or damage due to blow-up of spatter in the optical system including the machining lens and the protective glass provided in the machining head 13, and in the nozzles such as the beam nozzle 17 and the gas nozzle 18. Consequently, it is possible to prevent machining defects in the workpiece 30 to be cut next.

In addition, in the laser machining apparatus 100, the second waiting process is performed over the second waiting time WT2 at the start of emission of the second pulsed laser beam 1. Consequently, in the laser machining apparatus 100, at the start of formation of the joint portion J, the workpiece 30 can be stably melted by the second pulsed laser beam 1 stably emitted from the laser oscillator 11 under the second pulse condition, so that the joint portion width WJ and the joint portion melting length LM can be obtained as designed, and the joint portion J having the designed shape can be obtained.

In addition, in the laser machining apparatus 100, the formation of the joint portion J is controlled by combining the discharge of melt from the cut groove 33 in the first waiting process, the stabilization of the emission state of the second pulsed laser beam 1 in the second waiting process, the pulse condition of the second pulsed laser beam 1, and the movement state of the machining head 13, so that the joint portion J having the designed shape can be obtained. That is, in the laser machining apparatus 100, by appropriately controlling the discharge of melt from the cut groove 33, the emission state of the second pulsed laser beam 1, the pulse condition of the second pulsed laser beam 1, and the movement and stop of the machining head 13, it is possible to appropriately control the joint portion melting length LM and prevent machining defects in the joint portion J.

As described above, in the laser machining apparatus 100, the joint portion width WJ and the joint portion melting length LM can be obtained as designed, the joint portion J having the designed shape can be obtained, and the joint portion J having the designed quality can be stably produced throughout continuously repeated cutting of a plurality of workpieces 30.

Therefore, the laser machining apparatus 100 according to the first embodiment can achieve the effect of reliably forming a coupling piece that has a desired shape and couples the offcut 30b and the product 30a of the workpiece 30 in laser beam cutting.

The configurations described in the above-mentioned embodiment indicate examples. The configurations can be combined with another well-known technique, and some of the configurations can be omitted or changed in a range not departing from the gist.

### REFERENCE SIGNS LIST

1 pulsed laser beam; 2 machining gas; 11 laser oscillator; 12 optical path; 13 machining head; 14 drive unit; 15 detection unit; 16 control unit; 17 beam nozzle; 18 gas nozzle; 21 machining gas supply source; 30 workpiece; 30W1, 30W2 melt; 30a product; 30b offcut; 30c machining point; 31, J1 upper surface; 32 lower surface; 33, 34, 331, 332, 333, 334, 335 cut groove; 35 side surface; 41a, 41b solid line; 42 dashed-dotted line; 43a, 43b broken line; 100 laser machining apparatus; 201 CPU; 202 memory; 203 storage device; 204 display device; 205 input device; A1, A2 arrow; CP, CP11, CP12, CP13, CP14, CP15 machining path; CP1 first machining path; CP1s machining start point; CP2 second machining path; CPe machining end point; DJ joint portion depth; HA joint portion area; HJ joint portion height; J joint portion; Je end; LM joint portion melting length; P piercing hole; SP irradiation stop position; T workpiece thickness; WJ joint portion width; WT1 first waiting time; WT2 second waiting time.

1. A laser machining apparatus that performs cutting to separate a workpiece into a product and an offcut by irradiating the workpiece with a laser beam and ejecting gas to the workpiece, the laser machining apparatus comprising:
a machining head to irradiate the workpiece with the laser beam:
a gas nozzle to eject gas to the workpiece;
a drive unit to move at least one of the workpiece and the machining head;
a processor; and
a memory to store a program which, when executed by the processor, performs controlling irradiation with the laser beam, wherein
the processor performs a control of forming a cut groove by running a first laser beam along a predetermined machining path conforming to an outer shape of the product in an in-plane direction of an upper surface of the workpiece that is a surface irradiated with the laser beam:
a control of stopping irradiation with the first laser beam when an irradiation position of the laser beam reaches a position short of an end point on the machining path:
a control of continuing ejection of the gas over a predetermined first waiting time while the irradiation with the first laser beam is stopped:
a control of irradiating the workpiece with a second laser beam that gives less thermal energy to the workpiece per unit time than the first laser beam; and
a control of forming a joint portion coupling the product and the offcut by running the second laser beam in an uncut region where the cut groove is not formed on the machining path, the joint portion having a thickness smaller than a thickness of the workpiece, in a thickness direction of the workpiece.

2. The laser machining apparatus according to claim 1, wherein
the first laser beam and the second laser beam are pulsed laser beams, and
the second laser beam has a smaller output of the pulsed laser beam than the first laser beam, a smaller frequency of the pulsed laser beam than the first laser beam, and a smaller duty ratio of the pulsed laser beam than the first laser beam.

3. The laser machining apparatus according to claim 1, wherein
the uncut region is a region from the position short of the end point on the machining path to a start point of the machining path.

4. The laser machining apparatus according to claim 1, wherein
a height of the joint portion in the thickness direction of the workpiece is 40% to 60% of the thickness of the workpiece.

5. The laser machining apparatus according to claim 1, wherein
the first waiting time is 0.1 seconds or more.

6. (canceled)

7. A laser machining method for a laser machining apparatus to perform cutting to separate a workpiece into a product and an offcut by irradiating the workpiece with a laser beam and ejecting gas to the workpiece, the laser machining method comprising:
forming a cut groove by running a first laser beam along a predetermined machining path conforming to an outer shape of the product in an in-plane direction of an upper surface of the workpiece that is a surface irradiated with the laser beam;
stopping irradiation with the first laser beam when an irradiation position of the laser beam reaches a position short of an end point on the machining path:
continuing ejection of the gas over a predetermined first waiting time while the irradiation with the first laser beam is stopped:
irradiating the workpiece with a second laser beam that gives less thermal energy to the workpiece per unit time than the first laser beam; and
forming a joint portion coupling the product and the offcut by running the second laser beam in an uncut region where the cut groove is not formed on the machining path, the joint portion having a thickness smaller than a thickness of the workpiece, in a thickness direction of the workpiece.

8. The laser machining method according to claim 7, wherein
the first laser beam and the second laser beam are pulsed laser beams, and
the second laser beam has a smaller output of the pulsed laser beam than the first laser beam, a smaller frequency of the pulsed laser beam than the first laser beam, and a smaller duty ratio of the pulsed laser beam than the first laser beam.

9. The laser machining method according to claim 7, wherein
the uncut region is a region from the position short of the end point on the machining path to a start point of the machining path.

10. The laser machining method according to any one of claim 7, wherein
a height of the joint portion in the thickness direction of the workpiece is 40% to 60% of the thickness of the workpiece.

11. The laser machining method according to any one of claim 7, wherein
the first waiting time is 0.1 seconds or more.

12. (canceled)

13. The laser machining apparatus according to claim 1, wherein
after irradiating the workpiece with the second laser beam, the processor performs a control of keeping irradiation of the workpiece with the second laser beam over a predetermined second waiting time, without running the second laser beam.

14. The laser machining apparatus according to claim 13, wherein
the second waiting time is 0.1 seconds or more.

15. The laser machining apparatus according to claim 7, wherein
after the irradiating the workpiece with the second laser beam, keeping irradiation of the workpiece with the second laser beam over a predetermined second waiting time, without running the second laser beam.

16. The laser machining method according to claim 15, wherein
the second waiting time is 0.1 seconds or more.
